(19) United States
(12) Patent Application Publication
(10) Pub. No.: US 2013/0321867 A1
(43) Pub. Date: Dec. 5, 2013

(54) TYPOGRAPHICAL BLOCK GENERATION

(71) Applicant: Herve Dejean, Grenoble (FR)

(72) Inventor: Herve Dejean, Grenoble (FR)

(73) Assignee: XEROX CORPORATION, Norwalk, CT (US)

(21) Appl. No.: 13/484,708

(22) Filed: May 31, 2012

(51) Int. Cl. G06K 15/02

(52) U.S. Cl. 358/1.16

(57) ABSTRACT

Embodiments of a computer-implemented method for grouping one or more token elements comprising one or more characters in an input file. The method comprises computing a first leading distance between a first baseline of a first token element, and a second baseline of a second token element. The method further comprises defining a block with the first token element and the second token element, and characterizing the first leading distance as a leading distance of the block. The method further comprises computing a second leading distance between the second baseline and a third baseline of a third token element. The method furthermore comprises, grouping the third token element in to the block based on a first difference between the second leading distance and the leading distance of the block lying within a first predefined threshold value.

### TECHNICAL FIELD

The presently disclosed embodiments pertain to a file conversion process for scanned images, but not limited to the same.

### BACKGROUND

Legacy files are generally unusable for further processing, other than printing and viewing since a source format of contents in the legacy files are no longer available. Consequently, conversion of the legacy files becomes essential. However, the converted legacy files do not follow a proper logical structure since symbols, text, pictures, images, and/or a combination thereof present in the legacy files are misaligned.

### SUMMARY

According to aspects illustrated herein, a computer-implemented method is provided for grouping one or more token elements comprising one or more characters in an input file. In an embodiment, the method involves computing a first leading distance between a first baseline of a first token element and a second baseline of a second token element. The method further includes defining a block with the first token element and the second token element, and characterizing the first leading distance as a leading distance of the block. The method further includes computing a second leading distance between the second baseline and a third baseline of a third token element. The method furthermore involves, grouping the third token element in to the block based on a first difference between the second leading distance and the leading distance of the block lying within a first predefined threshold value.

### BRIEF DESCRIPTION OF DRAWINGS

The following detailed description of the embodiments of the disclosure can be better understood when read with reference to the appended drawings. The disclosure is illustrated by way of example, and is not limited by the accompanying figures, in which like references indicate similar elements.

FIG. 1 is a block diagram showing various modules of a system in accordance with an embodiment;

FIG. 2 is a flowchart illustrating a computer-implemented method for grouping one or more token elements in an input file in accordance with an embodiment;

FIG. 3 is an input file that is sent as input to the system in accordance with an embodiment;

FIG. 4 is a processed input file with bounding boxes and their geometric positions generated by an extraction module in accordance with an embodiment;

FIG. 5 is a snapshot that illustrates vertical neighborhood relationship between token elements in accordance with an embodiment;

FIG. 6 is a diagram that illustrates grouping of token elements in to a block in accordance with an embodiment;

FIG. 7 is a diagram illustrating construction of a baseline grid in a block in accordance with an embodiment;

FIG. 8 is an example of an output file of the system in accordance with an embodiment;

FIG. 9 is an over-segmented output file in accordance with an embodiment;

FIG. 10 is a diagram illustrating block merging in accordance with an embodiment;

FIG. 11 is a diagram illustrating overlapping blocks in accordance with an embodiment;

FIG. 12 is an output file having an under-segmented block produced by an Optical Character Recognition (OCR) engine in accordance with an embodiment; and

FIG. 13 is an output file that illustrates partitioning an under-segmented block in accordance with an embodiment.

### DETAILED DESCRIPTION

Definition of Terms: Terms not specifically defined herein should be given the meanings that would be given to them by one of skill in the art in light of the disclosure and the context. As used in the present specification and claims, however, unless specified to the contrary, the following terms have the meaning indicated.

Legacy file: A Legacy file corresponds to a document, retained in electronic form that is available in a legacy format. In an embodiment, the legacy format is an unstructured format or partially structured format. Examples of the legacy format include a Tagged Image File Format (TIFF), a Joint Photographic Experts Group (JPG) format, a Portable Document Format (PDF), any format that can be converted to PDF, and the like. In a further embodiment, the legacy format belongs to an image-based format (such as in a scanned file). According to this disclosure, a source format of contents in the legacy file is no longer available. Consequently, the legacy file can only be printed or viewed.

Print: A print corresponds to an image on a medium (such as paper, vinyl, and the like) that is capable of being read directly through human eyes, perhaps with magnification. The image can correspond to symbols, text, pictures, images, and/or a combination thereof. According to this disclosure, the image printed on the medium is considered as the print.

Input file: An input file is defined as a collection of data, including image data in any format, retained in an electronic form. Further, an input file can contain one or more pictures, symbols, text, blank or non-printed regions, margins, etc. According to this disclosure, the input file is obtained from symbols, text, pictures, images, and/or a combination thereof that originate on a computer or the like. Examples of the input file can include, but are not limited to, PDF files (such as PDF newspapers), an OCR engine processed files, and the like. In an embodiment, the input file corresponds to a file in a legacy format, retained in electronic form that may be no longer used since source format of contents in the input file is no longer available. In an alternate embodiment, the input file is generated from a print such as a newspaper.

Output file: An output file according to this disclosure contains one or more meaningful blocks that is generated by a system (disclosed herein) in accordance with the input file. The output file is a collection of data such as, symbols, text, pictures, images, and/or a combination thereof in any format, retained in electronic form.

Printing: Printing may be defined as a process of making predetermined data available for printing.

Leading distance: A leading distance is defined as a distance between two baselines.

Baseline: A baseline is defined as an invisible line on which one or more token elements are located.

Token element: A token element is defined as a group of characters.

Text element: A text element is defined as a group of token elements.

Vertical overlap: According to this disclosure, when two token elements located on consecutive baselines vertically fall on each other, then they are said to vertically overlap. In an embodiment, two token elements having the same font size are said to vertically overlap with each other.

Baseline grid: A baseline grid is defined as a grid consisting of one or more lines in a block. According to this disclosure, the lines are horizontal in orientation.

Uniform white space: A uniform whitespace corresponds to a valley in an image file.

Digital-born file: A digital-born file corresponds to a file that originated in a networked world, therefore existing as digital-born since inception.

The disclosure can be best understood by referring to the detailed figures and description set forth herein. The embodiments are discussed below with reference to the figures. However, those skilled in the art will readily appreciate that the detailed description given herein with respect to these figures is just for explanatory purposes, as the method and the system extend beyond the described embodiments. For example, those skilled in the art will appreciate, in light of the teachings presented, multiple alternate and suitable approaches, depending on the needs of a particular application, to implement the functionality of any detail described herein, beyond the particular implementation choices in the following embodiments described and shown.

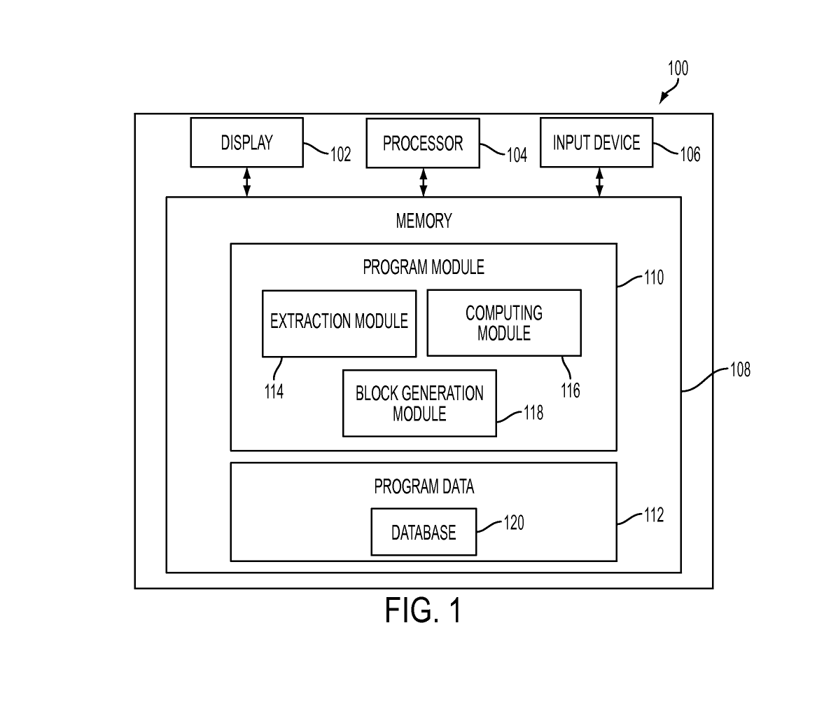

FIG. 1 is a block diagram showing various modules of a system 100 in accordance with an embodiment. The system 100 includes a display 102, a processor 104, a input device 106, and a memory 108. The display 102 is configured to display a user interface to a user of the system 100. The processor 104 is configured to execute a set of instructions stored in the memory 108. The input device 106 is configured to receive a user input. The memory 108 is configured to store a set of instructions or modules.

In an embodiment, the system 100 corresponds to a computing device such as, a Personal Digital Assistant (PDA), a smartphone, a tablet PC, a laptop, a personal computer, a mobile phone, a Digital Living Network Alliance (DLNA)-enabled device, and the like.

The display 102 is configured to display the user interface to the user of the system 100. The display 102 can be realized through several known technologies such as a Cathode Ray Tube (CRT) based display, a Liquid Crystal Display (LCD), a Light Emitting Diode (LED)-based display and an Organic LED display technology. Further, the display 102 can be a touch screen that can be configured to receive the user input.

In an embodiment, the display 102 displays an input file. In another embodiment, the display 102 displays an output file containing one or more blocks that are generated.

The processor 104 is coupled with the display 102, the input device 106, and the memory 108. The processor 104 is configured to execute the set of instructions stored in the memory 108. The processor 104 can be realized through a number of processor technologies known in the art. Examples of the processor 104 can be an X86 processor, a RISC processor, an ASIC processor, a CSIC processor, or any other processor. The processor 104 fetches the set of instructions from the memory 108 and executes the set of instructions.

The input device 106 is configured to receive the user input. Examples of the input device 106 may include, but are not limited to, a keyboard, a mouse, a joystick, a gamepad, a stylus, or a touch screen.

The memory 108 is configured to store the set of instructions or modules. Some of the commonly known memory implementations can be, but are not limited to, a Random Access Memory (RAM), a Read-Only Memory (ROM), a Hard Disk Drive (HDD), and a secure digital (SD) card. The memory 108 includes a program module 110 and a program data 112. The program module 110 includes a set of instructions that can be executed by the processor 104 to perform specific actions on the system 100. The program module 110 further includes an extraction module 114, a computing module 116 and a block generation module 118. The program data 112 includes a database 120. The extraction module 114 is configured to extract information indicative of one or more geometric positions of one or more token elements. The computing module 116 is configured to compute a leading distance between any two baselines of any two token elements. The block generation module 118 is configured to define the block with the one or more token elements.

The extraction module 114 is configured to extract information indicative of the one or more geometric positions of the one or more token elements. The extraction module 114 can correspond to an Optical Character Recognition (OCR) software.

The computing module 116 is configured to compute the leading distance between any two baselines of any two token elements. In an embodiment, the any two token elements vertically overlap with each other. In another embodiment, the any two token elements have similar font sizes. The computing module 116 is further configured to identify a reference baseline position corresponding to a longest text element in a block.

The block generation module 118 is configured to define the block with the one or more token elements. In an embodiment, the block generation module 118 is further configured to group the one or more token elements into the block. In another embodiment, the block generation module 118 is configured to construct a baseline grid in the block. In yet another embodiment, the block generation module 118 is further configured to assign the one or more token elements to one or more lines of the baseline grid. The block generation module 118 is further configured to merge the one or more blocks to form a single block. In an alternate embodiment, the block generation module 118 is further configured to partition a block into one or more blocks.

In an embodiment, the database 120 corresponds to a storage device that stores data required for grouping the one or more token elements in the input file. For example, the database 120 can be configured to store data related to the one or more geometric positions of the one or more token elements, the output file containing the generated one or more blocks. The database 120 can be implemented by using several technologies that are well known to those skilled in the art. Some examples of technologies may include, but are not limited to, MySQL®, Microsoft SQL®, etc. In an embodiment, the database 120 may be implemented as cloud storage. Examples of cloud storage may include, but are not limited to, Amazon E3®, Hadoop® distributed file system, etc.

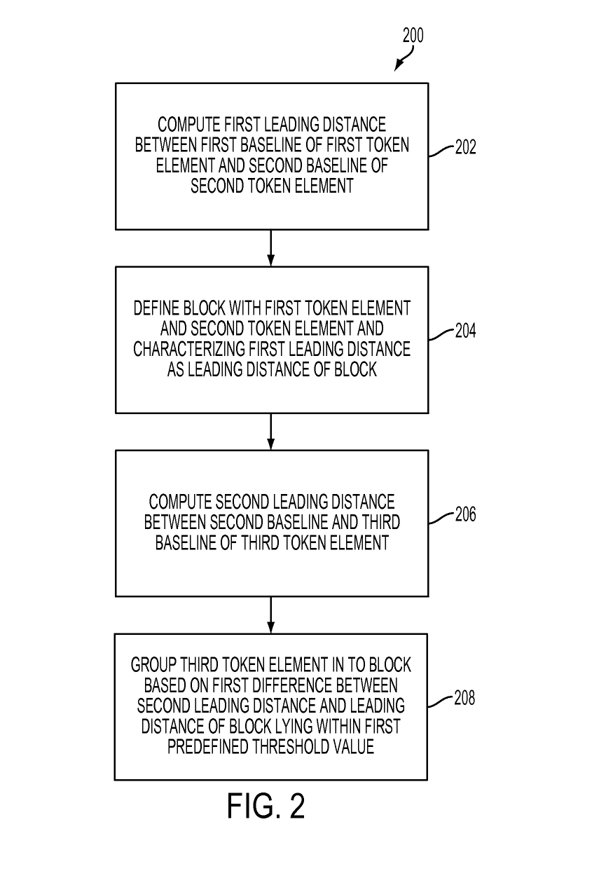

FIG. 2 is flowchart 200 illustrating a computer-implemented method for grouping the one or more token elements in the input file in accordance with an embodiment. FIG. 2 is explained in conjunction with FIG. 1.

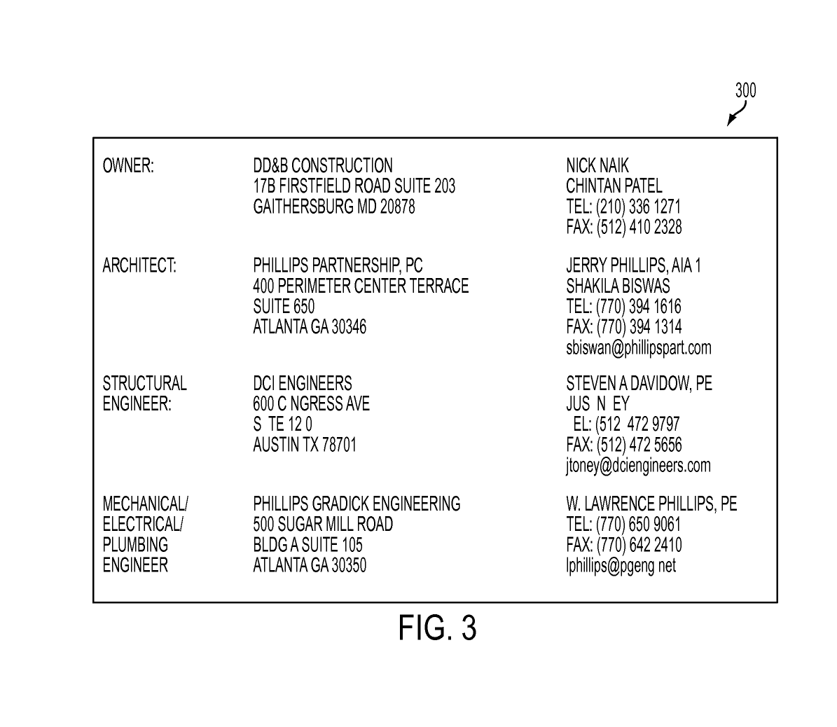

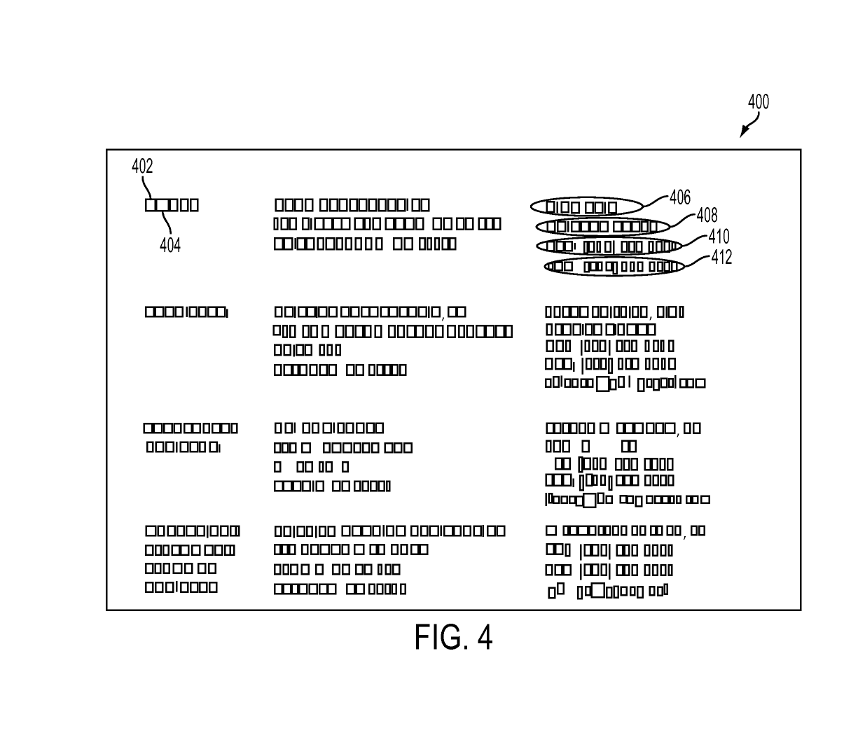

The extraction module 114 extracts the one or more geometric positions of the one or more token elements corresponding to the input file. FIG. 3 depicts an input file 300 that is sent as input to the system 100, in accordance with an embodiment. The extraction module 114 extracts the geometric positions of the one or more token elements present in the input file 300. In an embodiment, the extraction of the one or more geometric positions of the one or more token elements is performed by generating one or more bounding boxes corresponding to one or more characters in the input file 300. An example of a processed input file 400 with the one or more bounding boxes (such as a bounding box 402 and a bounding box 404) and their geometric positions generated by the extraction module 114 is depicted in FIG. 4.

The processed input file 400 includes the one or more geometric positions of the one or more token elements, such as, a first token element 406, a second token element 408, a third token element 410, a fourth token element 412, and so on. Further, the first token element 406 is located on a first baseline, the second token element 408 is located on a second baseline, the third token element 410 is located on a third baseline, the fourth token element 412 is located on a fourth baseline, and so on. In an embodiment, the extraction module 114 extracts the geometric information regarding the positions of one or more baselines from the input file 300.

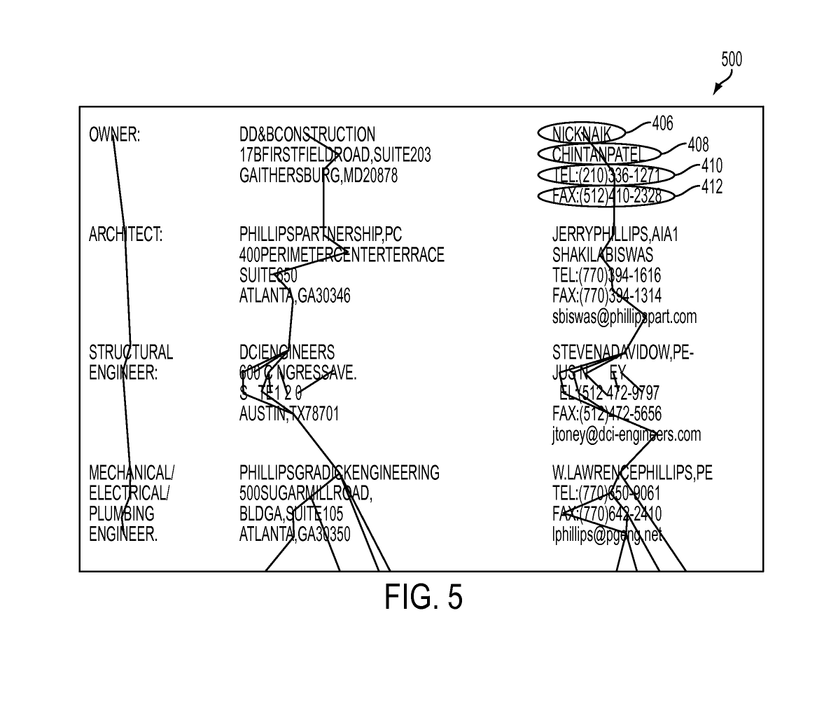

At step 202, a first leading distance between the first baseline of the first token element 406 and the second baseline of the second token element 408 is computed. FIG. 5 is a snapshot 500 that illustrates a vertical neighborhood relationship between the one or more token elements, in accordance with an embodiment. In order to compute the vertical neighborhood relationship between the one or more token elements, the computing module 116 computes the first leading distance, provided the first token element 406 and the second token element 408 vertically overlap with each other. In an embodiment, the first token element 406 and the second token element 408 have similar font sizes in order to vertically overlap with each other. In another embodiment, the one or more token elements having a minimal leading distance between them in comparison with the other token elements are considered vertical neighbors. A marked line 502 passing through the first token element 406 and the second token element 408 and many others illustrate the vertical neighborhood relationship between the one or more token elements.

At step 204, a block is defined with the first token element 406 and the second token element 408. The block generation module 118 defines the block with the first token element 406 and the second token element 408. Further, the block generation module 118 characterizes the first leading distance as a leading distance of the block. In an embodiment, the leading distance of the block is subjective to the block under consideration and may vary with every block. For example, a first predefined block can have “a leading distance of the first predefined block” as 3.5 mm. A second predefined block can have “a leading distance of the second predefined block” as 5.2 mm.

At step 206, the computing module 116 computes a second leading distance between the second baseline of the second token element 408 and the third baseline of the third token element 410. The computing module 116 computes the second leading distance provided the second token element 408 and the third token element 410 vertically overlap with each other.

At step 208, the block generation module 118 groups the third token element 410 in to the block. In an embodiment, the grouping of the third token element 410 in to the block is based on a first difference between the second leading distance and the leading distance of the block lying within a first predefined threshold value. The predefined threshold value is not subjective to a type of the input file but to a nature of the input file, such as, a PDF file, an OCR engine processed file, a digital-born file, and the like.

In an embodiment, the first predefined threshold value is considered to be equal to zero in the case of processing a PDF file. A PDF file does not require any threshold value since the PDF file stores the one or more geometric positions of the one or more token elements precisely. However, when processing an OCR engine processed file, an approximation and noise (depending on a quality of an image file) is required. The approximation is necessary due to the computation of the one or more geometric positions of the one or more token elements by an OCR engine. Therefore, in case of processing the OCR engine processed file, the third token element 410 is grouped in to the block when the first difference is within the first predefined threshold value. The first predefined threshold value is 3 typographical points (roughly 1 mm) for the OCR engine processed file.

In an embodiment, where the first difference is not within the first predefined threshold value, the third token element 410 is saved in the database 120 for future use.

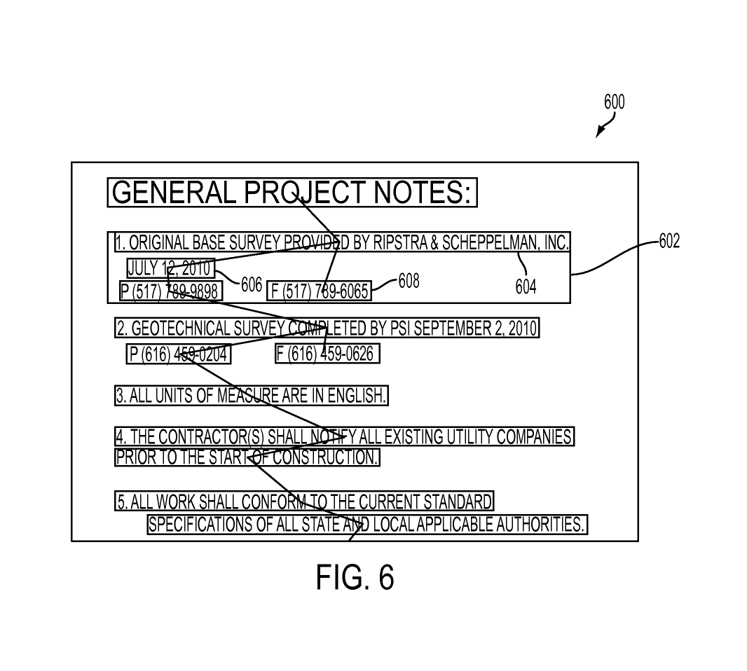

FIG. 6 is a diagram 600 that illustrates grouping of token elements in to a block in accordance with an embodiment. For example, let us consider a block 602, a token element “ORIGINAL . . . ” marked as 604, hereinafter referred to as “token element 604”, a token element “JULY 12, 2012” marked as 606, hereinafter referred to as “token element 606”, and a token element “F(517) 789-6065” marked as 608, hereinafter referred to as “token element 608”. During the process of grouping the one or more token elements in the block 602, the token element 608 is stored in the database 120 since a difference between a leading distance (between the token element 608 and the token element 604) and a leading distance of the block 602 is not within the first predefined condition. Subsequently, while grouping the token element 606 in to the block 602, the difference lies within the first predefined threshold value and the token element 608 is grouped in to the block 602.

In an embodiment, when the third token element 410 and the fourth token element 412 vertically overlap with each other, the fourth token element 412 is iteratively grouped in to the block by the block generation module 118. The grouping of the fourth token element 412 in to the block is based on a second difference between a third leading distance and the leading distance of the block lying within the first predefined threshold value. In this case, the third leading distance is computed between the fourth baseline and the third baseline by the computing module 116. Thus, the one or more token elements are iteratively grouped to generate one or more blocks.

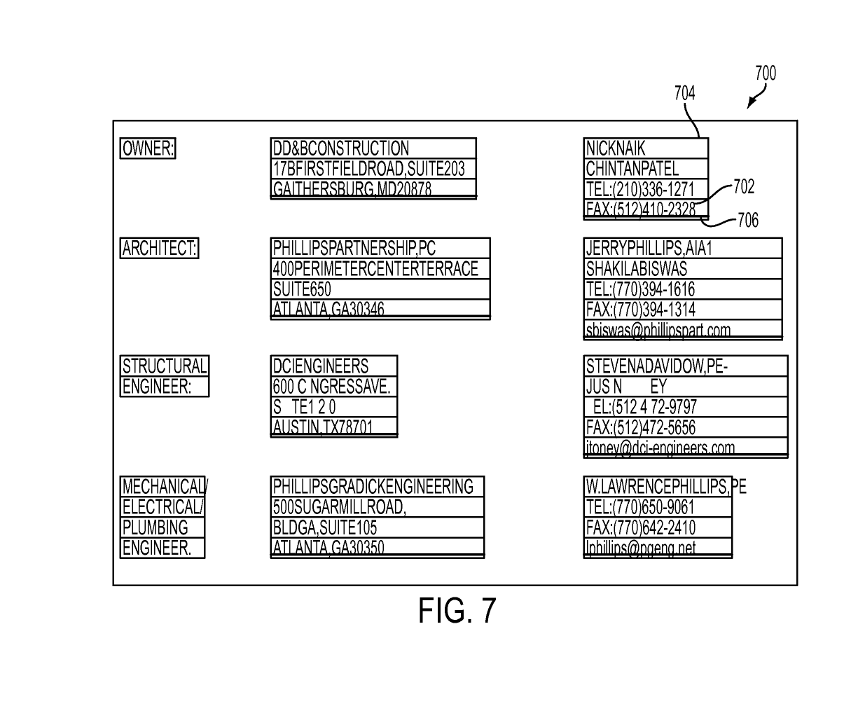

Subsequent to the generation of the one or more blocks, the block generation module 118 constructs a baseline grid in the one or more blocks. FIG. 7 is a diagram 700 illustrating construction of the baseline grid in a block 704 in accordance with an embodiment. Prior to the construction of the baseline grid, the computing module 116 identifies a reference baseline position corresponding to a longest text element in the block 704. For example, the computing module 116 identifies a text element “TEL:(210)338-1271” as the longest text element of the block 704. The block generation module 118 further constructs the baseline grid for the block 704 by considering the reference baseline position as a starting point. Further, a leading distance of the block 704 is added/subtracted with the reference baseline position to construct the baseline grid provided the reference baseline position remains within the block 704. For example, the leading distance of the block 704 is added to the reference baseline position to define the one or more lines of the baseline grid occurring below the reference baseline position. Further, the leading distance of the block 704 is subtracted from the reference baseline position to define the one or more lines occurring above the reference baseline position. Thus, the baseline grid for the block 704 is constructed.

Subsequent to the generation of the baseline grid, a first token element (such as a token element 702) is assigned to a first line (such as a line 706) of the baseline grid corresponding to the block 704. In an embodiment, the assigning is based on a third difference between a first baseline (such as a baseline of the token element 702) and the first line (such as the line 706) lying within a second predefined condition. The second predefined condition is such that the third difference is a minimal value. The minimal value for a digital-born file is in the range of 0 and 1 mm. The minimal value for an OCR engine processed file is in the range of 0 and 3 mm.

Further, the block generation module 118 is configured to arrange the first token element (such as the token element 702) horizontally on the first line (such as the line 706) based on a characteristic of the first token element (such as the token element 702). In an embodiment, the characteristic corresponds to the type of characters in the input file 300. For example, Unicode characters are arranged from either left to right or from right to left.

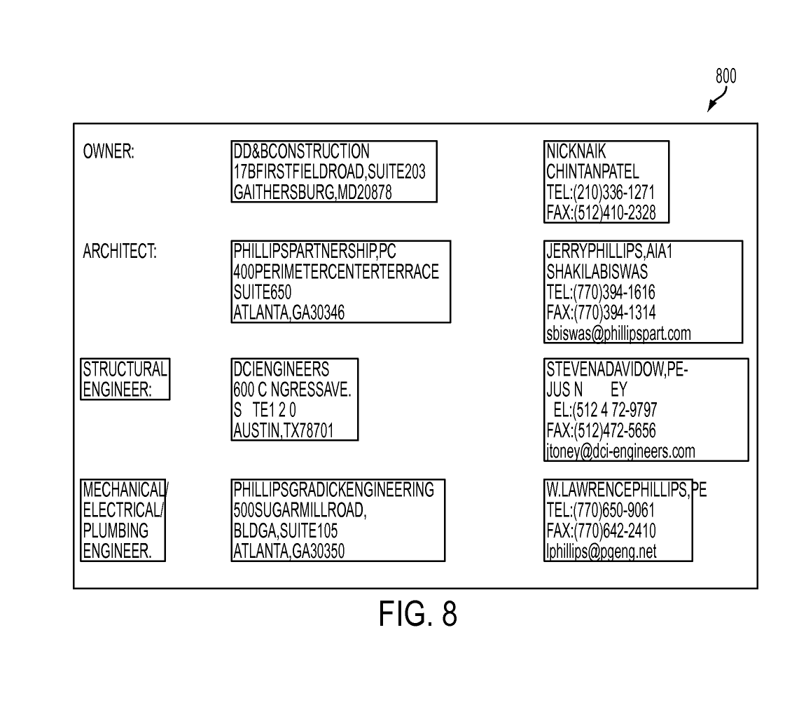

FIG. 8 is an example of an output file 800 in accordance with an embodiment. FIG. 8 shows the arrangement of various token elements on various lines in various blocks. Thus, various blocks are typographically generated.

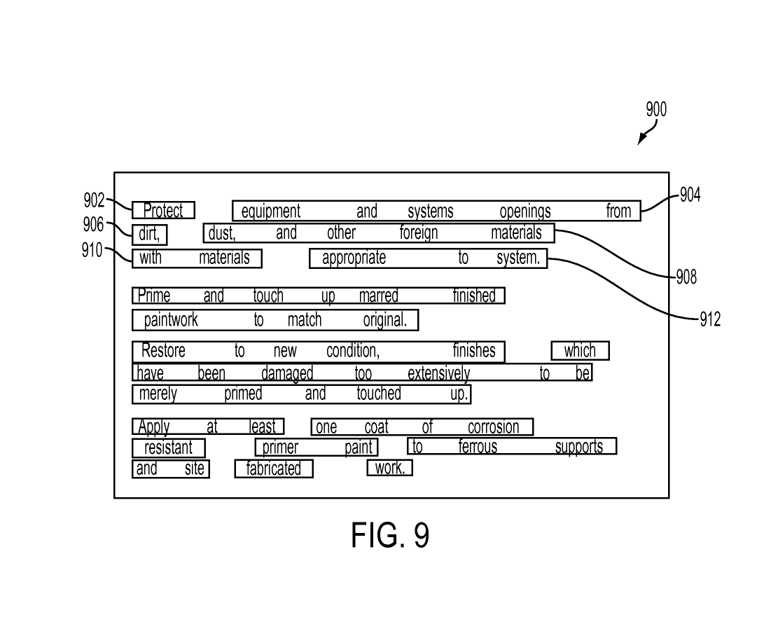

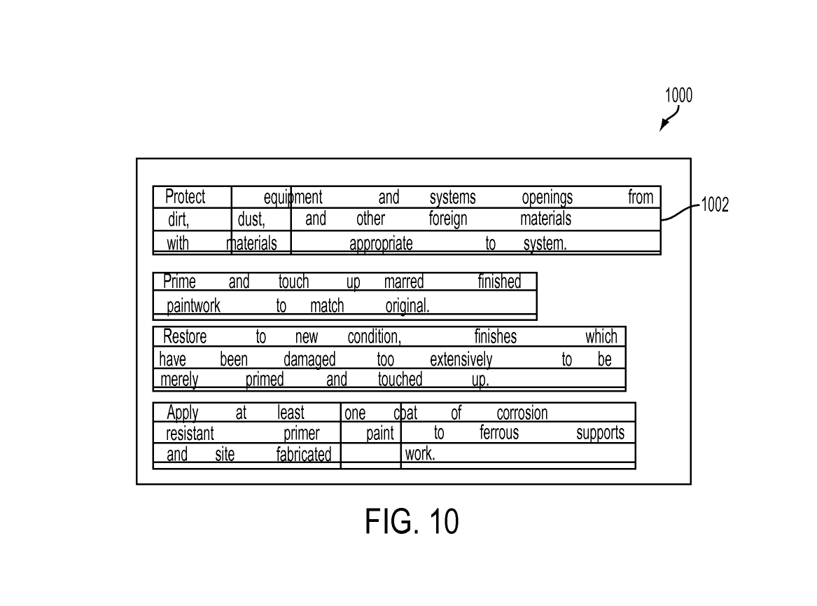

In an embodiment, one or more text elements are over segmented. Typically, an over segmented file includes a large number of blocks that are meaningless. Therefore, one or more blocks in an over-segmented output file 900 (refer to FIG. 9) are merged together, in order to generate one or more meaningful blocks. The merging is performed when a first baseline grid of a first block matches with a second baseline grid of a second block; and the one or more bounding boxes of the one or more token elements in the first block and the second block overlap with each other. FIG. 10 is a diagram 1000 illustrating block merging in accordance with an embodiment. For example, a baseline grid of a block 902 matches with another baseline grid of a block 904 and their bounding boxes overlap. Therefore, the block 902 and the block 904 are merged together. Subsequently, various blocks such as the block 902, the block 904, a block 906, a block 908, a block 910, and a block 912, that are merged together to generate a block 1002 (refer to FIG. 10).

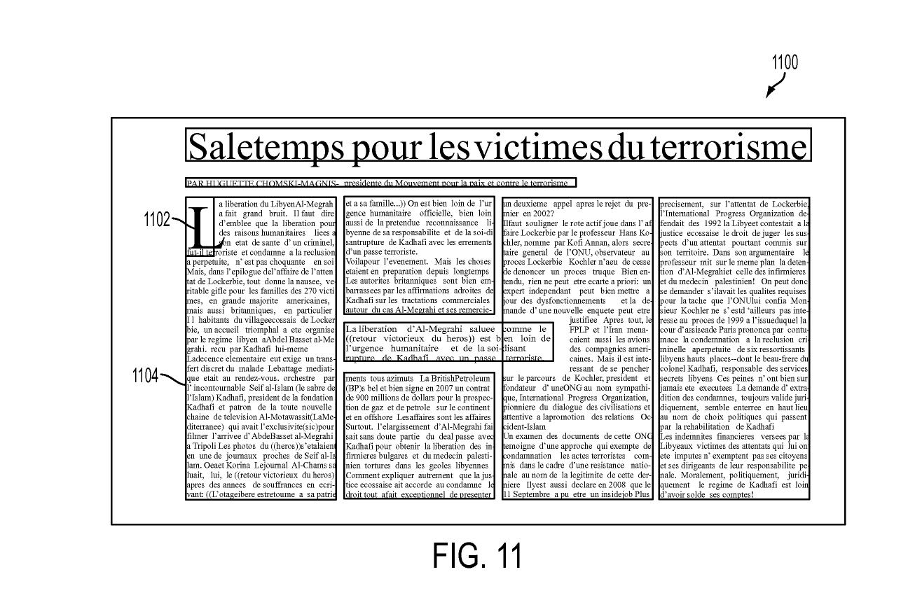

FIG. 11 is an output file 1100 having overlapping blocks in accordance with another embodiment. A block 1102 is composed of only one character. The block 1102 is merged with a block 1104 when the block 1102 overlaps with at least two lines of the block 1104 at the top left corner of the output file 1100.

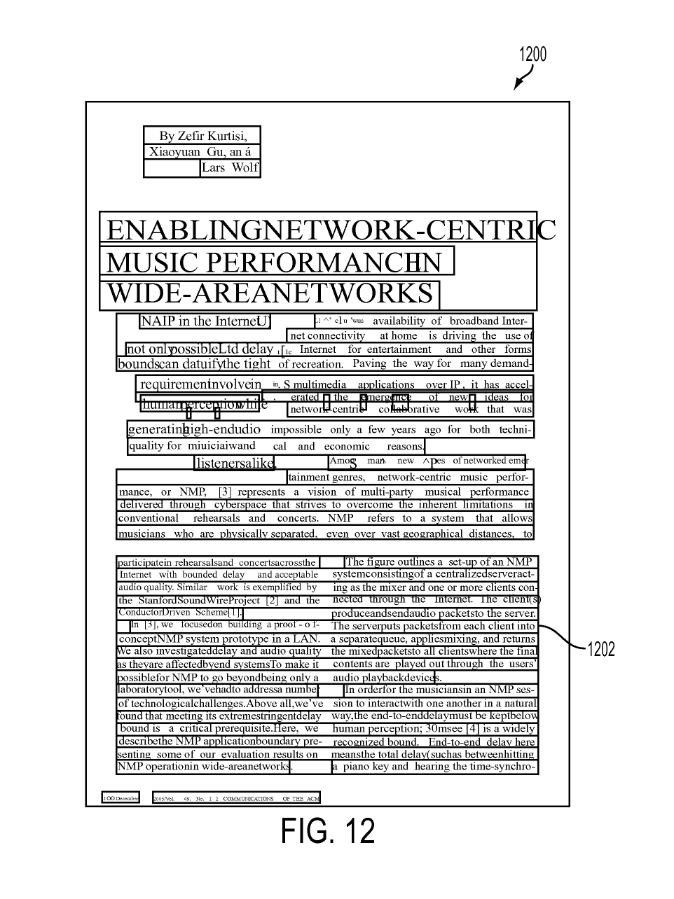

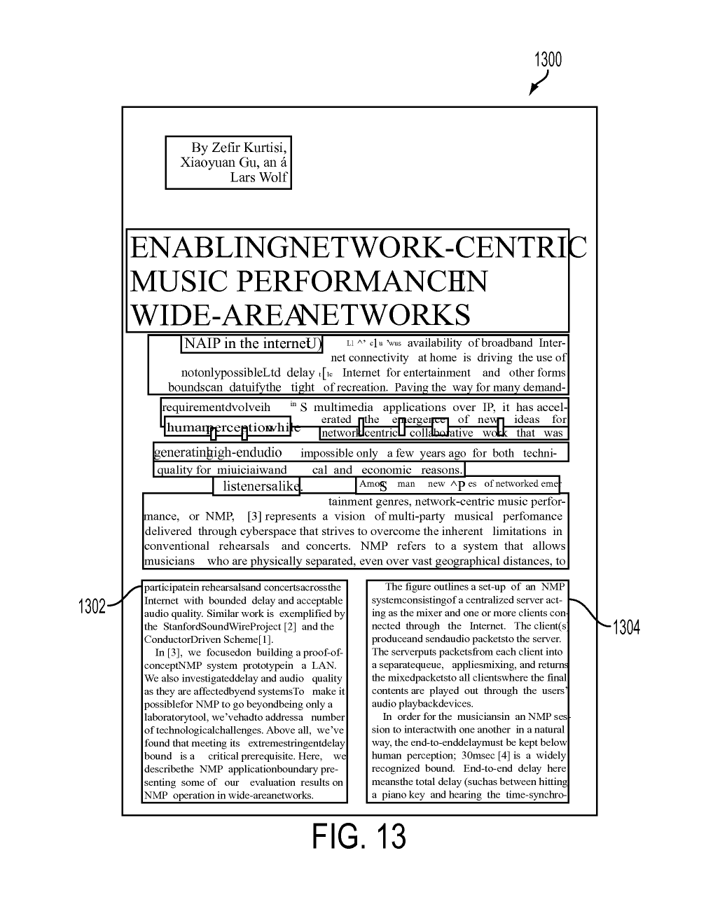

In an embodiment, when a block is under-segmented, the block is partitioned into one or more blocks based on a vertical alignment of one or more token elements on one or more lines of one or more baseline grids. An example of an output file 1200 having an under-segmented block 1202 produced by an Optical Character Recognition (OCR) engine in accordance with an embodiment is shown in FIG. 12. The under-segmented block 1202 is detected with a uniform vertical whitespace. In an embodiment, an XY-cut algorithm (Meunier et al.) is used to detect the uniform whitespace. Further, the under-segmented block 1202 has a plurality of token elements arranged with regular vertical alignment on either side of the uniform whitespace. Subsequently, the under-segmented block 1202 is corrected by partitioning the under-segmented block 1202 into two blocks (1302 and 1304—refer to FIG. 13) depicting two columns in an output file 1300.

In an embodiment, the generated blocks in an output file belong to a common format such as, an eXtensible Mark-up Language (XML). The common format is cross-platform compatible and less prone to obsolescence. Further, the generated blocks segment the input file into meaningful blocks that serve as input objects for several applications such as, caption detection, grid detection, footnote detection, and the like.

In an embodiment, the generated blocks are used for generating semantic elements such as paragraphs.

In an embodiment, the generated blocks can be marked in to various components such as (header, footer, and the like) by performing a document logical analysis without the need for post-segmentation.

The disclosed methods and systems, as described in the ongoing description or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive. The storage device may also be other similar means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or any other similar device, which enables the computer system to connect to databases and networks such as LAN, MAN, WAN, and the Internet. The computer system facilitates inputs from a user through input device, accessible to the system through an I/O interface.

The computer system executes a set of instructions that are stored in one or more storage elements in order to process input data. The storage elements may also contain data or other information as desired. The storage element may be in the form of an information source or a physical memory element present in the processing machine.

The programmable or computer-readable instructions may include various commands that instruct the processing machine to perform specific tasks such as the steps that constitute the method of the disclosure. The method and systems described can also be implemented using only software programming or using only hardware or by a varying combination of the two techniques. The disclosure is independent of the programming language used and the operating system in the computers. The instructions for the disclosure can be written in all programming languages, including, but not limited to ‘C’, ‘C++’, ‘Visual C++’, and ‘Visual Basic’. Further, the software may be in the form of a collection of separate programs, a program module with a larger program, or a portion of a program module, as in the disclosure. The software may also include modular programming in the form of object-oriented programming. The processing of input data by the processing machine may be in response to user commands, results of previous processing, or a request made by another processing machine. The disclosure can also be implemented in all operating systems and platforms, including, but not limited to, ‘Unix’, ‘DOS’, ‘Android’, ‘Symbian’, and ‘Linux’.

The programmable instructions can be stored and transmitted on computer-readable medium. The programmable instructions can also be transmitted using data signals. The disclosure can also be embodied in a computer program product comprising a computer readable medium, the product capable of implementing the above methods and systems, or the numerous possible variations thereof.

While various embodiments have been illustrated and described, it will be clear that the disclosure is not limited to these embodiments. Numerous modifications, changes, variations, substitutions, and equivalents will be apparent to those skilled in the art without departing from the spirit and scope of the disclosure as described in the claims.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art, and they are also intended to be encompassed by the following claims.

The claims can encompass embodiments in hardware, software, or a combination thereof.

The word “printer” as used herein encompasses any apparatus, such as a digital copier, bookmaking machine, facsimile machine, multi-function machine, and the like, which performs a print outputting function for any purpose.

What is claimed is:

1. A computer-implemented method for grouping one or more token elements in an input file, the one or more token elements comprising one or more characters, the computer implemented method comprising:
computing a first leading distance between a first baseline of a first token element and a second baseline of a second token element, wherein the first token element and the second token element vertically overlap with each other;
defining a block with the first token element and the second token element, wherein the first leading distance is characterized as a leading distance of the block;
computing a second leading distance between the second baseline and a third baseline of a third token element, wherein the second token element and the third token element vertically overlap with each other; and
grouping the third token element in to the block based on a first difference between the second leading distance and the leading distance of the block lying within a first predefined threshold value.

2. The computer-implemented method of claim 1 further comprising extracting information indicative of one or more geometric positions of the one or more token elements.

3. The computer-implemented method of claim 1 further comprising iteratively grouping a fourth token element in to the block based on a second difference between a third leading distance and the leading distance of the bock lying within the first predefined threshold value, wherein the third token element and the fourth token element vertically overlap with each other.

4. The computer-implemented method of claim 3, wherein the third leading distance is computed between a fourth baseline corresponding to the fourth token element and the third baseline of the third token element, the third token element and the fourth token element vertically overlapping with each other.

5. The computer-implemented method of claim 1 further comprising identifying a reference baseline position corresponding to a longest text element in the block, wherein the longest text element includes at least one of the one or more token elements.

6. The computer-implemented method of claim 5 further comprising constructing a baseline grid in the block based on the leading distance of the block and the reference baseline position.

7. The computer-implemented method of claim 6 further comprising assigning the first token element to a first line of the baseline grid based on a third difference between the first baseline and the first line of the baseline grid lying within a second predefined threshold value.

8. The computer-implemented method of claim 7 further comprising arranging the first token element horizontally on the first line of the baseline grid based on a characteristic of the first token element.

9. The computer-implemented method of claim 1, wherein the grouping further comprises storing the third token element based on the first difference between the second leading distance and the leading distance of the block not lying within the first predefined threshold value.

10. The computer-implemented method of claim 1 further comprising merging one or more blocks, wherein a first baseline grid of a first block matches with a second baseline grid of a second block.

11. The computer-implemented method of claim 1 further comprising partitioning the block into one or more blocks based on a vertical alignment of the one or more token elements on one or more lines of one or more baseline grids.

12. A system for grouping one or more token elements in an input file, the one or more token elements comprising one or more characters, the system comprising:
a computing module configured to:
compute a first leading distance between a first baseline of a first token element and a second baseline of a second token element, wherein the first token element and the second token element vertically overlap with each other; and
compute a second leading distance between the second baseline and a third baseline of a third token element, wherein the second token element and the third token element vertically overlap with each other; and
a block generation module configured to:
define a block with the first token element and the second token element, wherein the first leading distance is characterized as a leading distance of the block; and
group the third token element in to the block based on a first difference between the second leading distance and the leading distance of the block lying within a first predefined threshold value.

13. The system of claim 1 further comprises an extraction module configured to extract information indicative of one or more geometric positions of the one or more token elements.

14. The system of claim 12, wherein the block generation module is further configured to group a fourth token element in to the block based on a second difference between a third leading distance and the leading distance of the bock lying within the first predefined threshold value, wherein the third token element and the fourth token element vertically overlap with each other.

15. The system of claim 12, wherein the computing module is further configured to identify a reference baseline position corresponding to a longest text element in the block, wherein the longest text element includes at least one of the one or more token elements.

16. The system of claim 15, wherein the block generation module is further configured to construct a baseline grid in the block based on the leading distance of the block and the reference baseline position.

17. The system of claim 16, wherein the block generation module is further configured to assign the first token element to a first line of the baseline grid based on a third difference between the first baseline and the first line of the baseline grid lying within a second predefined threshold value.

18. The system of claim 17, wherein the block generation module is further configured to arrange the first token element horizontally on the first line of the baseline grid based on a characteristic of the first token element.

19. The system of claim 12, wherein the block generation module is further configured to store the third token element based on the first difference between the second leading distance and the leading distance of the block not lying within the first predefined threshold value.

20. The system of claim 12, wherein the block generation module is further configured to merge one or more blocks, wherein a first baseline grid of a first block matches with a second baseline grid of a second block.

21. The system of claim 12, wherein the block generation module is further configured to partition the block into one or more blocks based on a vertical alignment of the one or more token elements on one or more lines of one or more baseline grids.

22. A computer program product for use with a computer, the computer program product comprising a computer readable program code embodied therein for grouping one or more token elements in an input file, the one or more token elements comprising one or more characters, the computer readable program code comprising:
program instruction means for computing a first leading distance between a first baseline of a first token element and a second baseline of a second token element, wherein the first token element and the second token element vertically overlap with each other;
program instruction means for defining a block with the first token element and the second token element, wherein the first leading distance is characterized as a leading distance of the block;
program instruction means for computing a second leading distance between the second baseline and a third baseline of a third token element, wherein the second token element and the third token element vertically overlap with each other; and
program instruction means for grouping the third token element in to the block based on a first difference between the second leading distance and the leading distance of the block lying within a first predefined threshold value.
